(19) United States
(12) Patent Application Publication
(10) Pub. No.: US 2010/0138409 A1
(43) Pub. Date: Jun. 3, 2010

(54) INFORMATION DEVICE, MEDIUM AND METHOD

(75) Inventor: Kanako NAKASA, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 12/696,349

(22) Filed: Jan. 29, 2010

Related U.S. Application Data
(63) Continuation of application No. PCT/JP2007/065166, filed on Aug. 2, 2007.

(51) Int. Cl. G06F 17/30

(52) U.S. Cl. 707/722; 707/756; 707/705; 707/E17.006; 707/E17.009

(57) ABSTRACT

In an information device in which moving images are stored, moving image data is provided to a plurality of applications or the moving image usage function between a plurality of devices is improved. The information device comprises a database section for storing the moving image data in association with identification information for identifying the moving image data, a receiving section for receiving a read out request for the moving image data specified by the identification information from any of the applications for reproducing the moving image data, an output section for reading out the moving image data specified by the read out request from the database section to pass it to the application of the source of the read out request, and an execution section for executing the applications for reproducing the moving image data outputted from the output section.

### CROSS-REFERENCE TO RELATED APPLICATION

This is a continuation of Application PCT/JP2007/065166, filed on Aug. 2, 2007, now pending, the contents of which are herein wholly incorporated by reference.

### FIELD

The present invention relates to an information device utilizing pictures.

### BACKGROUND

Nowadays, there is a rapid spread of information devices which provide functions by use of the pictures. For example, a majority of mobile phones are capable of capturing a static picture, a moving picture, etc. Further, some of personal computers are capable of recording the moving pictures of TV programs.

In the conventional frameworks, however, in the case of sharing the picture among a plurality of applications on one single device, or in the case of sharing the picture among a plurality of devices, many frameworks lack in convenience. Especially, an interface easily handling the moving picture was not provided to the application utilizing the moving picture.

For instance, the device accumulated with the moving pictures was not provided with the function of easily utilizing the moving picture by an application program other than reproducing the moving picture. Moreover, the function was not sufficient, which provides the moving pictures accumulated in a first device to a second device and processes the moving pictures by the application program running on the second device.

[Patent document 1] Japanese Patent Laid-Open Publication No. 2006-253960

[Patent document 2] Japanese Patent Laid-Open Publication No. 2005-20440

[Patent document 3] International Laid-Open Pamphlet WO2002/091259

### SUMMARY

One aspect of an embodiment is an information device including: a database unit stored with moving picture data in the way of being associated with identifying information for identifying the moving picture data; an accepting unit accepting a read request for the moving picture data specified by the identifying information from any one of a plurality of applications which reproduce the moving picture data; a data management unit reading the moving picture data specified by the read request from the database unit and handing over the moving picture data to the requester application making the read request; and an execution unit executing the plurality of applications which reproduce the moving picture data handed over from the data management unit.

The object and advantage of the embodiment will be realized and attained by means of the elements and combinations particularly pointed out in the appended claims.

It is to be understood that both the foregoing general description and the following detailed description are exemplary and explanatory only and are not restrictive of the invention, as claimed.

### BRIEF DESCRIPTION OF DRAWINGS

FIG. 1 is a block diagram illustrating a configuration of an information processing device according to one embodiment.

FIG. 2 is a diagram explaining the information processing device.

FIG. 3 is a diagram illustrating a display example based on a telephone directory application.

FIG. 4 is a diagram illustrating a display example based on a wallpaper application

FIG. 5 is a diagram illustrating a display example based on a diary application.

FIG. 6 is a diagram illustrating a display example based on an album application

FIG. 7 is an associative diagram of a program on the information processing device.

FIG. 8 is a diagram illustrating a data structure of a telephone directory database.

FIG. 9 is a diagram illustrating a data structure of a wallpaper database.

FIG. 10 is a diagram illustrating a data structure of a diary database.

FIG. 11 is a diagram illustrating a data structure of an album database.

FIG. 12 is a flowchart of a telephone directory registering process of a telephone directory program.

FIG. 13 is a flowchart of a telephone directory display process.

FIG. 14 is a diagram illustrating an information system in another embodiment.

FIG. 15 is a diagram illustrating a data structure of a moving picture data management table.

FIG. 16 is a diagram illustrating a synchronizing process.

FIG. 17 is a diagram illustrating a process of a moving picture data management device.

FIG. 18 is a diagram illustrating an example of a process in which it is determined based on a user ID whether a closed range of the moving picture data is to be deleted or not.

FIG. 19 is a diagram illustrating a configuration of providing the moving picture database on the side of a moving picture request device.

### DESCRIPTION OF EMBODIMENT(S)

An information processing system according to an aspect of one embodiment will hereinafter be described with reference to the drawings.

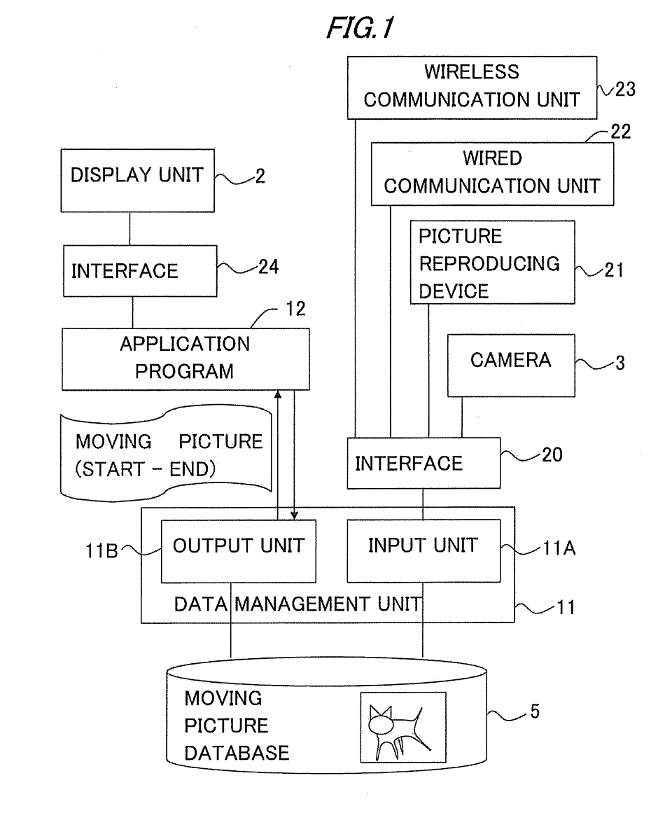

FIG. 1 is a block diagram illustrating a configuration of the present information processing device. The information processing device includes a moving picture database 5 (corresponding to a database unit), an input unit 11A which inputs moving picture data to the moving picture database 5, and an output unit 11B which outputs the moving picture data from the moving picture database 5.

The moving picture database 5 retains plural categories of moving picture data. Each category of moving picture data is stored in a file specified by a moving picture data file name. Further, the input unit 11A and the output unit 11B are realized by a program executed on the information processing device, and configure a data management unit 11.

The moving picture is inputted to the input unit 11A from one or more external devices via an interface 20. The external devices are exemplified such as other information processing devices connected to a camera 3, a picture reproducing device 21 and a wired communication unit 22 and also other information processing devices connected to a wireless communication unit 23.

The camera 3 is exemplified by, e.g., a CCD (Charge Coupled Device) camera, a MOS (Metal-Oxide-Semiconductor) image sensor, etc. The picture reproducing device 21 is exemplified such as a DVD (Digital Versatile Disk) reproducing device, a CD (Compact Disc) reproducing device, a hard-disk-based TV recording device and a TV receiver.

The wired communication unit 22 (corresponding to a first example of a communication unit) is exemplified by a LAN interface, an ADSL (Asymmetric Digital Subscriber Line) line, an optical communication line, a cable TV network, etc. The wireless communication unit 23 (corresponding to a second example of the communication unit) is exemplified such as a wireless LAN interface, an access device to a mobile phone network, and an access device to a PHS (Personal Handyphone System).

Further, the interface 20 is exemplified by, for instance, a USB (Universal Serial Bus), a Fibre Channel, IEEE1394 and so on. The input unit 11A detects a user's operation, inputs the moving picture data from these external devices and stores the inputted data in the moving picture database 5.

The output unit 11B provides the moving picture data to an application program executed on the information processing device. The application program designates the moving picture data file name which specifies the moving picture data and a necessary range (from starting time to ending time) in the moving picture data. The output unit 11B hands over, to the application program 12, the moving picture data in the range from the starting time to the ending time in the designated moving picture file. Moreover, a publicly opened range (publicly closed range) of each category of moving picture is defined in the moving picture database 5. The output unit 11B only the open range (publicly opened range) in the designated moving picture data file, and hands over the extracted range to the application program 12.

The application program 12 displays on a display unit 2 the moving picture handed over together with the data intrinsic to the application program 12 via an interface 24. The interface 24 is exemplified by, e.g., a VGA (Video Graphics Array) etc. Further, the display unit 2 is exemplified such as a liquid crystal display and an electroluminescence panel.

### First Embodiment

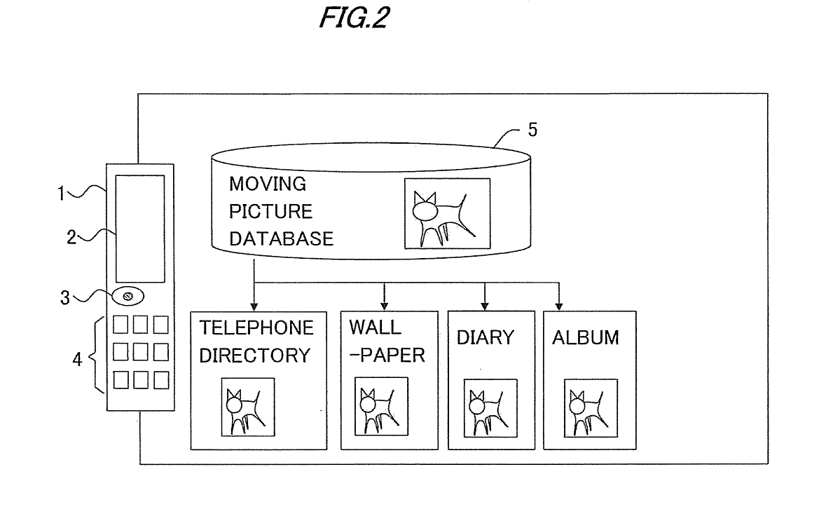

The information processing device according to a first embodiment of the present invention will hereinafter be described with reference to the drawings of FIGS. 2 through 13. FIG. 2 is a diagram illustrating the information processing device of the first embodiment. In the first embodiment, the information processing device is constructed of, e.g., a mobile phone 1 incorporating a camera. The information processing device includes the display unit 2 disposed on an operation surface of the mobile phone 1, a variety of keys 4 and the camera 3 which captures a moving picture and a static picture. Moreover, the information processing device includes the moving picture database 5 stored with the moving pictures. The moving picture database 5 provides the moving pictures to a variety of application programs such as a telephone directory, wallpaper, a diary and an album.

The information processing device has a configuration of a general type of mobile phone 1 which includes, i.e., a communication unit performing communications with a base station, a memory such as the moving picture database 5 stored with the data or the variety of programs, a CPU (Central Processing Unit) (corresponding to an execution unit) which executes the variety of program and manages the moving picture database 5 etc, and an input/output interface (e.g., an infrared-ray communication unit, a USB interface) etc which inputs and outputs the data from and to the external devices. In FIG. 2, however, illustrations of the communication unit, the memory, the CPU and the I/O interface are omitted.

The moving picture database 5 is stored with the moving picture data of the moving pictures captured by the camera 3, the moving picture data received from the communication unit, or the moving picture data inputted from the external devices via the I/O interface.

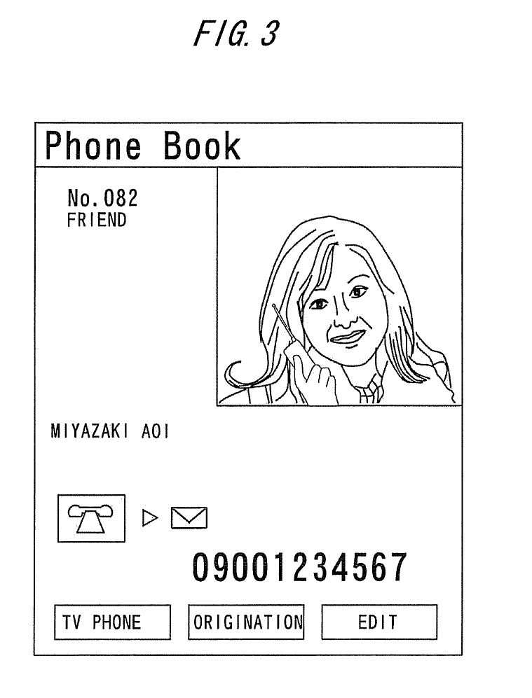

FIG. 3 illustrates an example of how the moving picture is displayed based on a telephone directory application. The telephone directory application displays, on the display unit 2, the telephone directory data including a comment (e.g., “Friend” in FIG. 3) containing a type of a recipient (or destination) of an outgoing call (or originating call) of the telephone, a name of the recipient of the outgoing call of the telephone, a moving picture (a screen image, reproduced from the moving picture data and displayed on the display unit 2 etc, is simply termed the moving picture) related to a telephone number and the recipient of the outgoing call. Further, the telephone directory application displays menu buttons for starting up respective functions such as “TV telephone”, “Origination” and “Edit”.

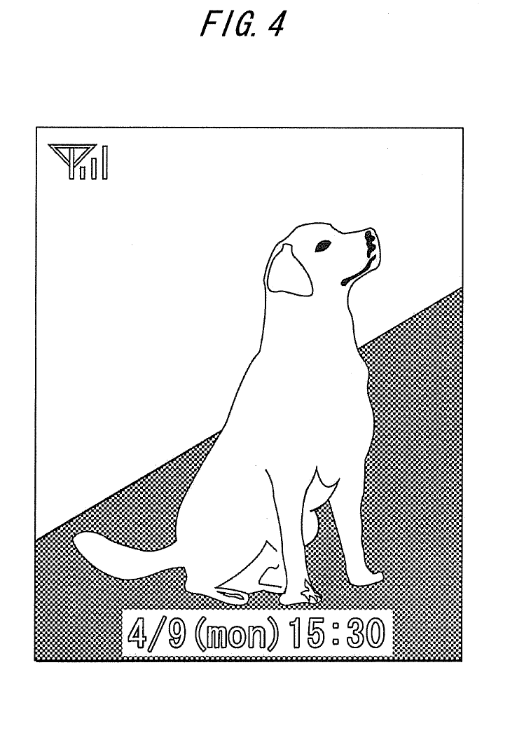

FIG. 4 illustrates a display example using a wallpaper application. The wallpaper application displays the designated moving picture on a background of the display unit 2 of the information processing device.

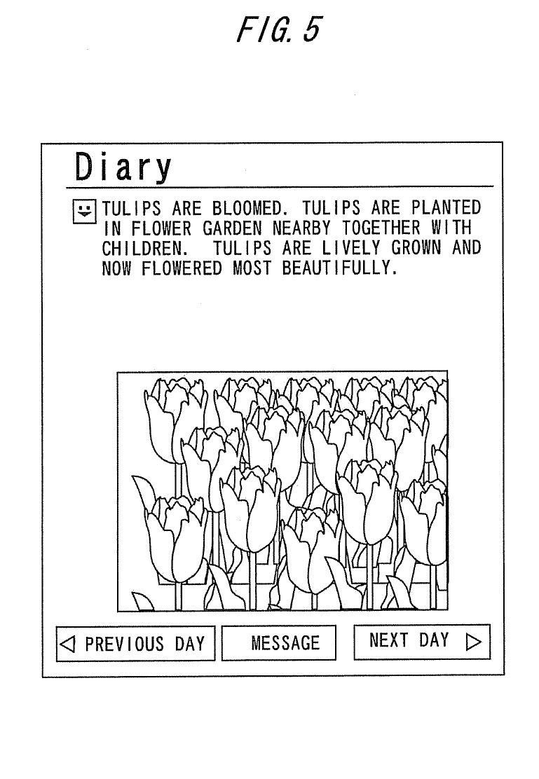

FIG. 5 depicts a display example using a diary application. The diary application displays a written diary and a moving picture related to this written diary on the display unit 2 of the information processing device. Furthermore, the diary application displays “Previous day” for displaying the diary on the day previous to the diary being displayed, “Message” for starting up a diary input function, “Next day” for displaying the diary on the day next to the diary being displayed, and so on.

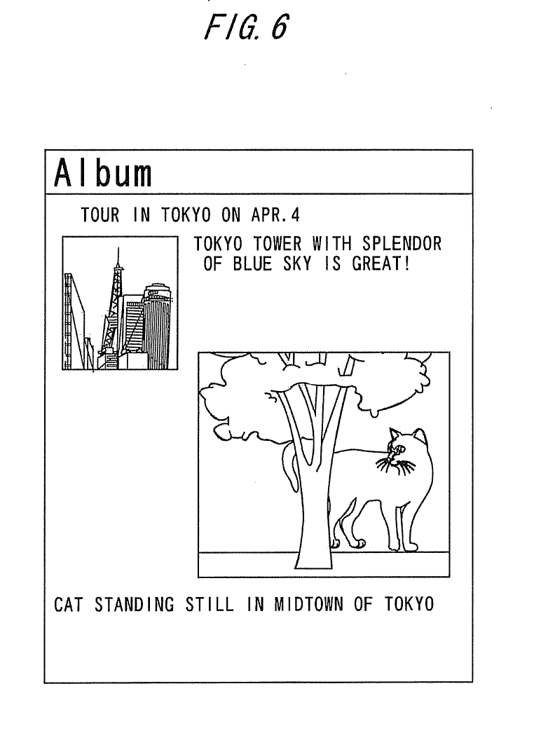

FIG. 6 depicts a display example using an album application. The album application displays one or more moving pictures and the comment on each moving picture on the display unit 2 of the information processing device.

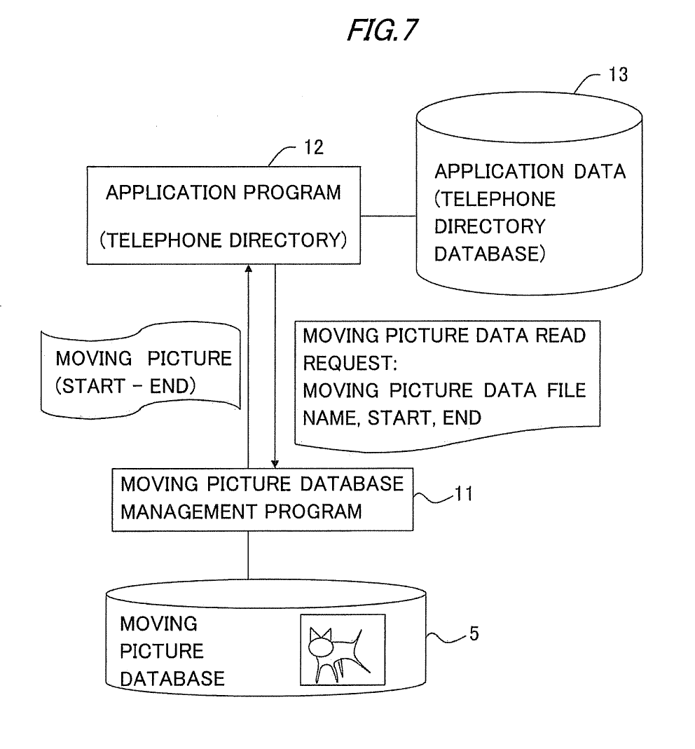

FIG. 7 illustrates an associative diagram of the programs on the information processing device. As depicted in FIG. 7, the information processing device executes, on the CPU, a moving picture database management program 11 for managing the moving picture database 5 and the application program 12 linking up with the moving picture database management program 11, thereby providing the functions.

The application programs 12 represent a variety of applications such as the “Telephone directory”, the “Wallpaper”, the “Diary” and the “Album”. Each application program 12 manages intrinsic application data 13. The application data 13 is exemplified by, e.g., a telephone directory database for the telephone directory application, a wallpaper database for the wallpaper application, a diary database for the diary application, and an album database for the album application.

The application program 12 inputs a moving picture data read request to the moving picture database management program 11. The moving picture data read request contains a reading target moving picture data file name, the starting time and the ending time. Herein, the starting time and the ending time are pieces of information for defining a want-to-obtain time zone in the moving picture data. The starting time and the ending time are specified by a point of time in a time axis whose origin (time 0) is set to the top (a first frame) of the moving picture data.

The moving picture database management program 11, upon accepting the moving picture data read request, reads the moving picture data ranging from the specified starting time and ending time from the designated moving picture data file, and hands over the readout data to the application program 12.

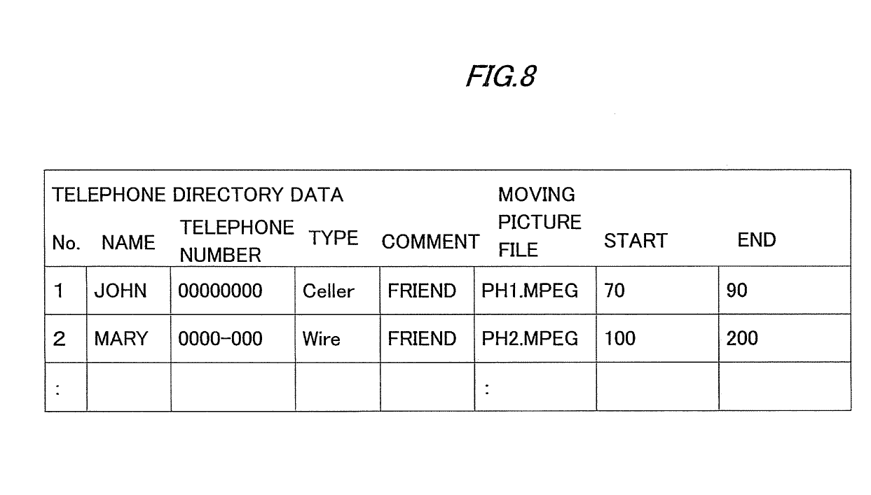

FIG. 8 illustrates a data structure of the telephone directory database. Each row in FIG. 8 shows a record of the database and corresponds to one set of telephone directory data. One set of telephone directory data contains fields such as a name of the recipient of the outgoing call of the telephone, a telephone number, a type of the telephone, a comment, a file name of the moving picture data file written in the telephone directory data, the starting time and the ending time. In these fields, the starting time represents a reproduction start position of the moving picture to be reproduced when displaying the telephone directory data and also indicates the time in the start position when the top (first frame) of the moving picture is set to the reference time (origin, 0 h 00 min 00 sec). Further, the ending time similarly represents a reproduction end position of the moving picture and also indicates the time in the end position when the top of the moving picture is set to the reference time.

The telephone directory application, when displaying the telephone directory data, reads the telephone directory data of the relevant recipient of the outgoing call out of the telephone directory database. Hereafter, a case that the information processing device carries out the process by executing the program will be also expressed such that the program executes the process.

Moreover, the telephone directory application generates the moving picture data read request from the file name of the moving picture data file, the starting time and the ending time, which are set in the telephone directory data, and inputs the thus-generated request to the moving picture database management program 11. Then, the telephone directory application displays, on the display unit 2, the telephone directory data together with the moving picture data received from the moving picture database management program 11.

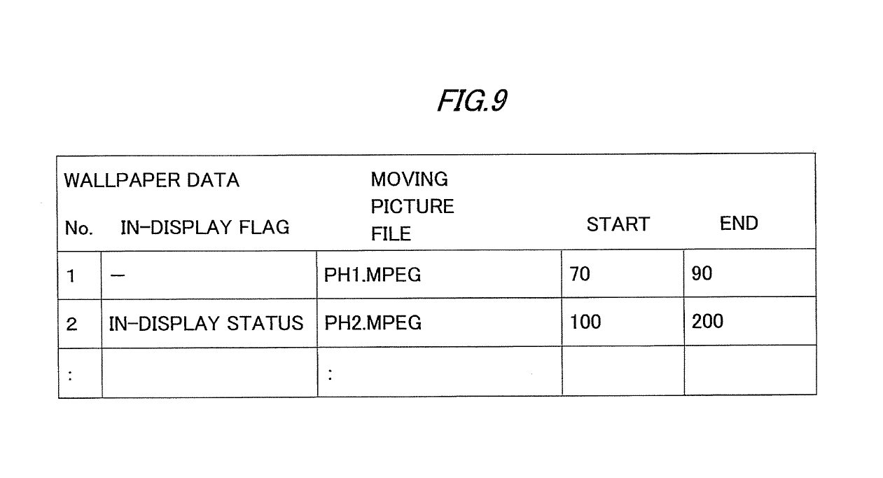

FIG. 9 illustrates a data structure of the wallpaper database. Each row in FIG. 9 shows a record of the database and corresponds to one set of data for managing the wallpaper. The wallpaper management data contains an in-display flag showing whether being in display or not, the moving picture data file name, the starting time and the ending time. The wallpaper application, when displaying the background of the display unit 2, reads one piece of wallpaper management data with “in-display” being in set in the in-display flag from within plural pieces of wallpaper management data in the wallpaper database. Moreover, the wallpaper application generates the moving picture data read request from the file name of the moving picture data file, the starting time and the ending time, which are set in the wallpaper management data, and inputs the thus-generated request to the moving picture database management program 11. Then, the wallpaper application displays the moving picture data received from the moving picture database management program 11 on the display unit 2.

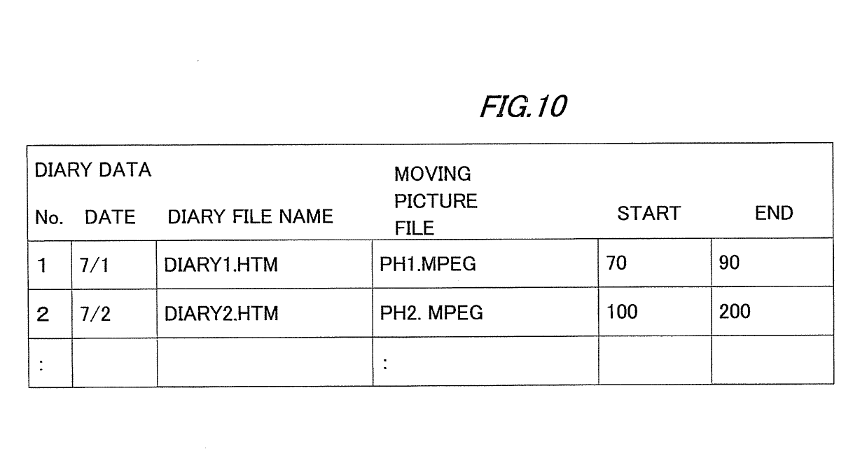

FIG. 10 depicts a data structure of the diary database. Each row in FIG. 10 shows a record of the database and corresponds to diary management data for managing a diary on a per-day basis. The diary management data contains a diary file name of a diary file stored with a text of the diary, a moving picture data file name for specifying a moving picture data file of the moving picture inserted into the diary, the starting time and the ending time. The diary application, when displaying the diary on the display unit 2, reads the diary management data from the diary database. Moreover, the diary application generates the moving picture data read request from the file name of the moving picture data file, the starting time and the ending time, which are set in the diary management data, and inputs the thus-generated request to the moving picture database management program 11. Then, the diary application displays, on the display unit 2, the moving picture data received from the moving picture database management program 11 together with the text of the diary.

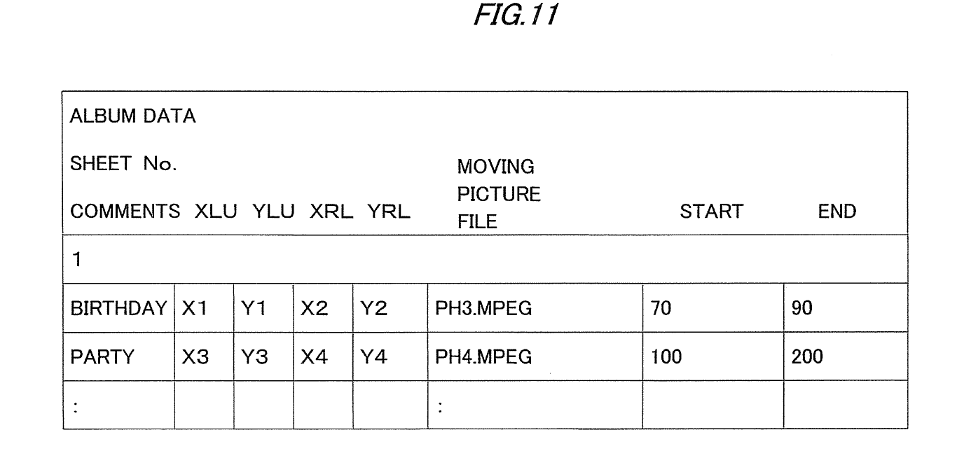

FIG. 11 depicts a data structure of the album database. Each row in FIG. 11 shows a record of the database and corresponds to album management data for managing one page of the album. The album management data contains a comment inserted in the album, left upper coordinates (XLU, YLU) and right lower coordinates (XRU, YRU) in a moving picture window, a moving picture data file name specifying the moving picture, the starting time and the ending time. The left upper coordinates and the right lower coordinates are the coordinates for specifying an intra-one-page position of the album.

The album application, when displaying the album on the display unit 2, reads the relevant album management data from the album database. Further, the album application generates the moving picture data read request from the file name of the moving picture data file, the starting time and the ending time, which are set in the album management data, and inputs the thus-generated request to the moving picture database management program 11. Then, the album application displays, in the moving picture window on the display unit 2, the moving picture data received from the moving picture database management program 11 together with the comment of the album.

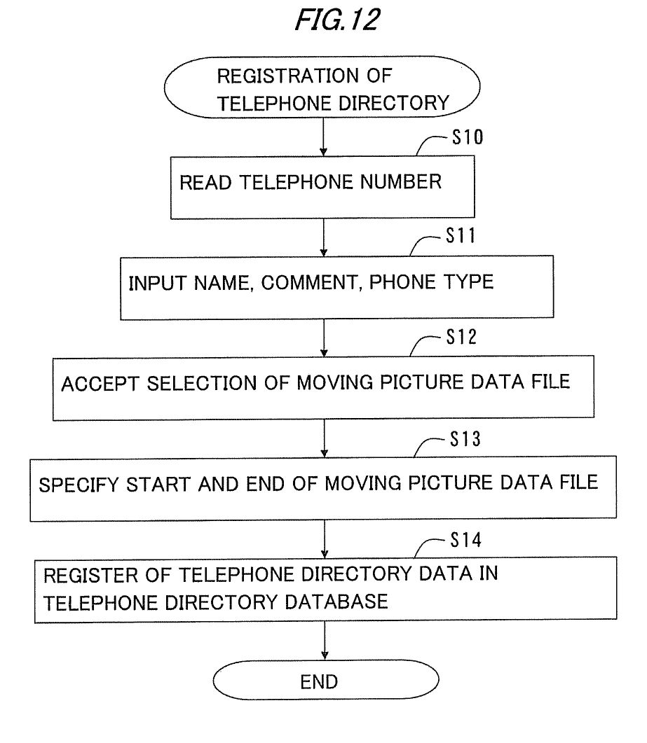

FIG. 12 illustrates a flowchart of a telephone directory registering process of the telephone directory program by way of one example of the application program 12. In this process, the information processing device, to begin with, reads the telephone number of the recipient, specified by the user, of the outgoing call (S10). The telephone number of the recipient of the outgoing call is specified from a key input from the user, a call originating history and a call incoming history, etc.

Next, the information processing device accepts inputs of the name of the recipient of the outgoing call, the comment, the type of the telephone, etc from the user (S11). Subsequently, the information processing device accepts selection of the moving picture data file (S12). The moving picture data file is, normally, a file associated with the recipient of the outgoing call in the telephone directory. In this case, the information processing device obtains a list of the moving picture data files from the moving picture database management program 11 and displays this list on the display unit 2. The user manipulates a cursor with the keys on the information processing device, thus selecting the desired moving picture data file.

Next, the information processing device accepts the inputs of the starting time and the ending time in the moving picture data file (S13). Then, the information processing device registers, in the telephone directory database, the telephone directory data containing the telephone number and the name of the recipient of the outgoing call, the comment, the type of the telephone, the moving picture data file, the starting time and the ending time described above (S14).

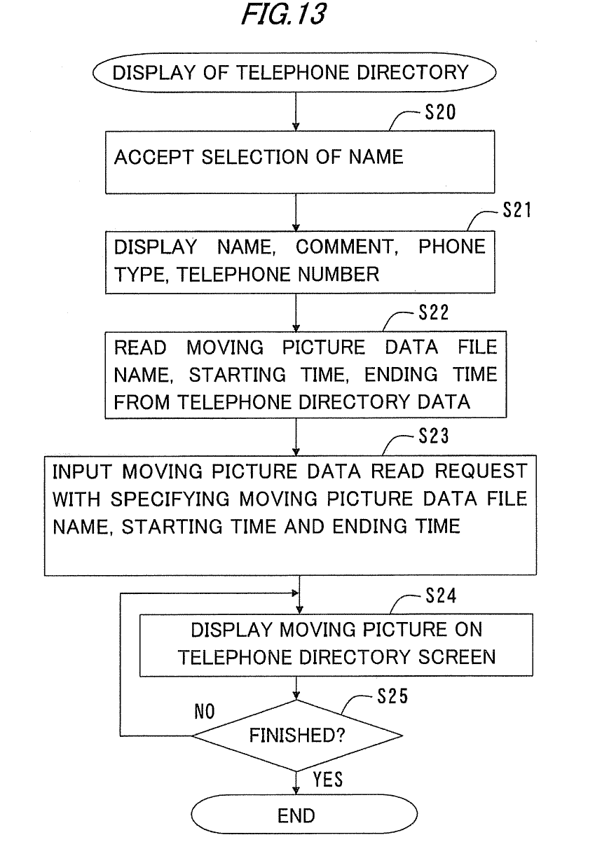

FIG. 13 illustrates a flowchart of a telephone directory display process of the telephone directory program. In this process, the information processing device, at the first onset, accepts the selection of the name etc which specifies a destination of the originated call (S20). For example, the information processing device displays the list of the telephone directory data and prompts the user to select the destination of the originated call.

Then, the information processing device displays the name, the comment, the type of the telephone, the telephone number, etc, which are set in the telephone directory data (S21). Next, the information processing device reads the moving picture data file name, the starting time and the ending time from the telephone directory data (S22).

Subsequently, the information processing device specifies the moving picture data file name, the starting time and the ending time, and inputs the moving picture data read request to the moving picture database management program 11 (S23).

Then, the information processing device displays, on the display unit 2, the moving picture data handed over from the moving picture database management program 11 together with the telephone directory data (S24). This display continues till the end is specified by the user (in the case of NO in S25). Subsequently, when detecting the end operation of the user, the information processing program terminates the telephone directory display process (in the case of YES in S25). Herein, the end operation includes also the originating operation of the telephone in addition to the display end operation.

Herein, the discussion on the telephone directory application has been made. However, the processes via the interface with the moving picture database management program 11 are the same with other applications. As discussed above, according to the information processing device in the first embodiment, the moving picture data acquired from the variety of input sources is accumulated in the moving picture database 5 and can be utilized for the multifarious applications.

### Second Embodiment

The first embodiment has discussed the example of accumulating the moving picture data acquired from the variety of input sources in the moving picture database 5 and utilizing the moving picture data for the multifarious applications in the information processing device such as the mobile phone.

A second embodiment will discuss an example of an information processing system configured by a device which manages the moving picture data and a device which requests this management device for the moving picture data and is thus provided with the moving picture data.

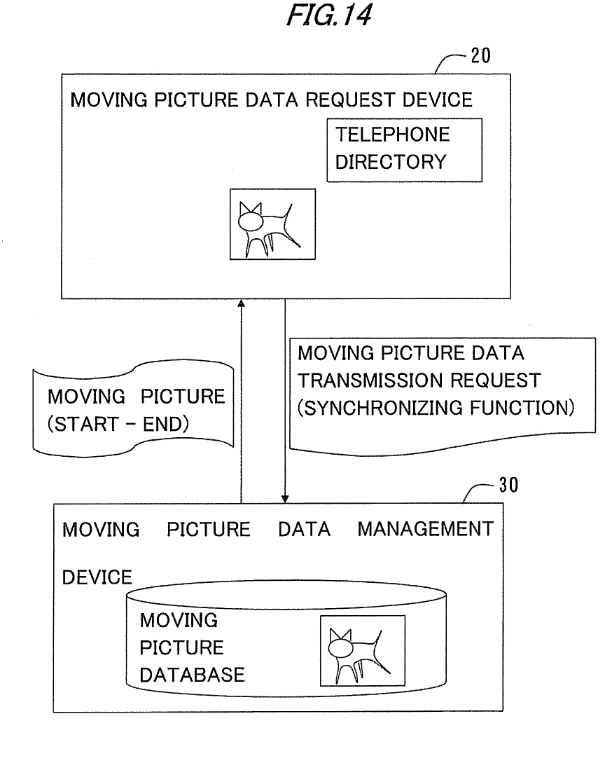

FIG. 14 is a diagram illustrating an architecture of the information processing system. As in FIG. 14, the information processing system includes a moving picture data request device 20 and a moving picture data management device 30. The moving picture data request device 20 has the data such as the telephone directory data, the wallpaper management data, the diary management data and the album management data, and executes the application. Herein, the moving picture data request device 20 is exemplified by, e.g., the mobile phone, a PDA (Personal Digital Assistant), a personal computer, a digital TV, etc.

Moreover, the moving picture data request device 20 executes a synchronizing process at predetermined timing. The synchronizing process is a process for synchronizing the moving picture data between the moving picture data request device 20 and the moving picture data management device 30. The predetermined timing is a set time interval, set startup timing or is just when a designated event occurs.

In the synchronizing process, the moving picture data request device 20 obtains the list of the moving picture data files retained by the moving picture data management device 30. Subsequently, the list of the moving picture data files is compared with the actually-retained moving picture data file. Then, if the obtained list contains the moving picture data file that is not retained by the moving picture data request device 20, the moving picture data request device 20 sends a transmission request of this moving picture data to the moving picture data management device 30. An available scheme is, however, that an update date/time is previously recorded in the list of the moving picture data files and it is determined whether or not the update date/time in the obtained list is later than the update date/time of the moving picture data file retained by the moving picture data request device 20. Then, if the update date/time in the obtained list is later than the update date/time of the moving picture data file retained by the moving picture data request device 20, the moving picture data request device 20 may send the transmission request of the moving picture data to the moving picture data management device 30.

At this time, the moving picture data management device 30 extracts the moving picture data ranging from the starting time to the ending time, which is defined as the range that may be disclosed to the outside, and transmits the extracted moving picture data to the moving picture data request device 20. Herein, the moving picture data management device 30 is exemplified such as the mobile phone, the PDA, the personal computer, the digital TV and a recording device having a built-in hard disk.

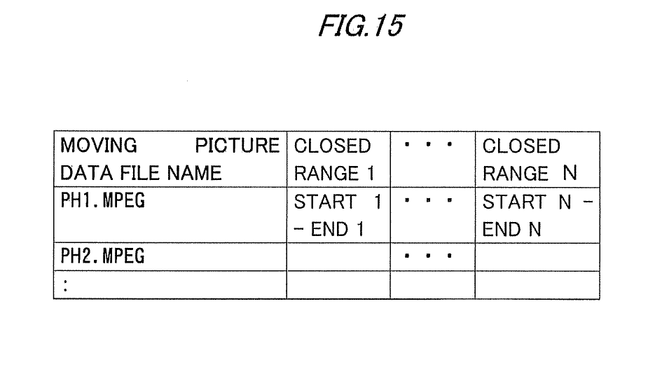

FIG. 15 illustrates a data structure of a moving picture data management table retained by the moving picture data management device 30. Each row in FIG. 15 shows management data for managing one set of moving picture data. The management data contains a moving picture data file name, and a closed range 1, . . . a closed range N. The moving picture data file name is a name of the management target moving picture data file.

The closed range 1, . . . the closed range N each contain the starting time and the ending time, thereby specifying a time range in which the moving picture data is not permitted to be disclosed to the public. Herein, the starting time and the ending time each indicate the reproducing time from the top of the moving picture. Note that a substitute for storing the closed range 1, . . . the closed range N may be to specify an open range by use of the starting time and the ending time. In this case also, similarly to the case in FIG. 15, the storage in the moving picture data management table may be done such as an open range 1, . . . an open range N.

The user may set the openable range or the closed range via an input means, e.g., a key 4 etc of the information processing device and may store the range in the moving picture database 5. The information processing device executing this process corresponds to a data range accepting unit.

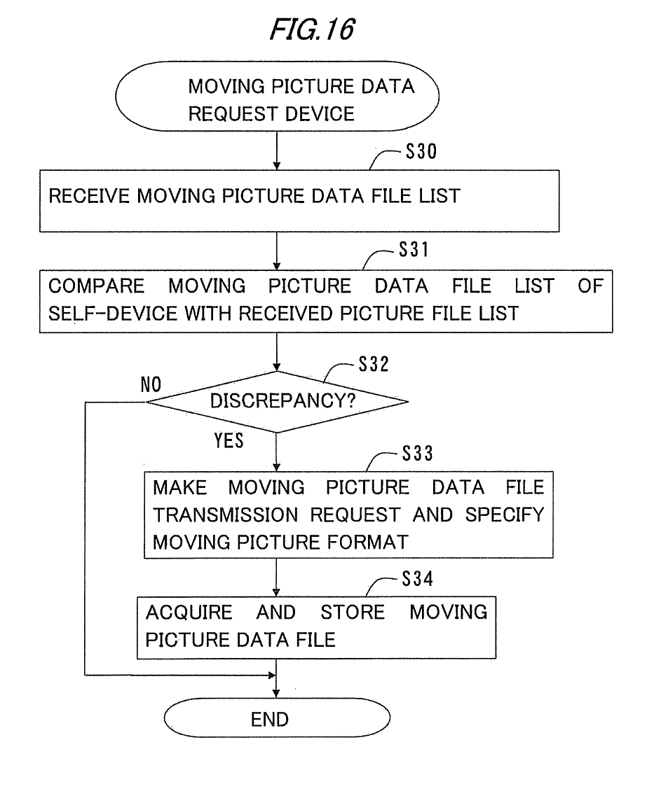

FIG. 16 illustrates a synchronizing process of the moving picture data request device 20. In this process, at first, the moving picture data request device receives the list of the moving picture data files from the moving picture data management device 30 (S30). Then, the received list of the moving picture data files is compared with the list of the moving picture data files retained by the moving picture data request device 20 (S31).

Then, it is determined whether or not there is a discrepancy between the received list and the retained list of the moving picture data files (S32). Herein, the “discrepancy” includes a case in which any one of the moving picture files in the received list does not exist in the list, or a case in which the update date/time of any one of the moving picture files in the received list is later than the retained moving picture data files.

If determined to be the discrepancy in S32, the moving picture data request device 20 transmits the transmission request of the moving picture data file to the moving picture data management device 30 (S33). This moving picture data file transmission request contains designation of a moving picture format. The designation of the moving picture data format is exemplified such as designating the moving picture format (MPEG2 etc), and a resolution and a size of the moving picture. Then, the moving picture data request device 20 acquires the moving picture data from the moving picture data management device 30 and stores the acquired data in the moving picture database of the self-device (S34).

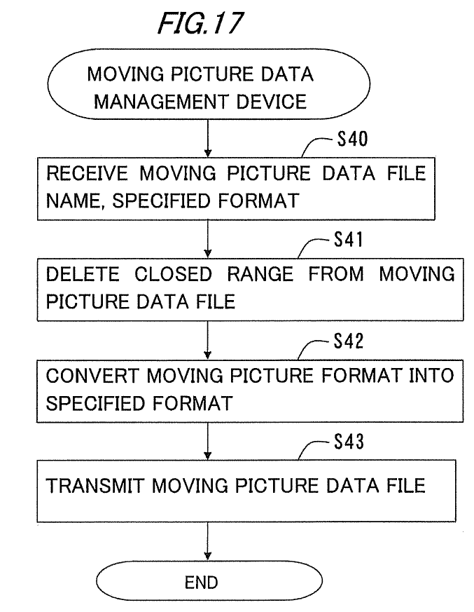

FIG. 17 depicts a process of the moving picture data management device 30. In this process, the moving picture data management device 30 receives the moving picture data transmission request in which to designate the moving picture file name and the format from the moving picture data request device 20 (S40). The moving picture data management device 30 executing this process corresponds to an accepting unit.

Next, the moving picture data management device 30 reads the designated moving picture data file from the moving picture database 5. Then, in the moving picture data contained in the moving picture data file, the closed range is deleted (S41). It is noted, in the case of retaining the open range of the moving picture data in the moving picture data management table, only the open range thereof may be extracted.

Subsequently, the moving picture data management device 30 converts the designated moving picture data into a designated format (S42). Then, the moving picture data management device 30 transmits the format-converted moving picture data to the moving picture data request device 20 (S43).

As discussed above, according to the information processing system in the second embodiment, the moving picture data is managed by the moving picture data management device 30 and is provided to the moving picture data request device 20 with the recognition that the moving picture data does not exist in the moving picture data request device 20 during the synchronizing process. In this case, the moving picture is converted on the side of the moving picture data management device 30 into the format requested by the moving picture data request device 20. Accordingly, even when the moving picture data request device 20 is a device with insufficient resources such as the mobile phone and the PDA, the moving picture data in the required format can be provided in a state where a rise in load on the moving picture data request device 20 is restrained.

Moreover, in the information processing system, when the moving picture data management device 30 provides the moving picture data, the process of deleing the closed range but extracting the open range, is executed. This process enables the external devices to be provided with the data that may be opened to the public in such a way that the moving picture data management device 30 manages the moving picture data containing the data undesirable for the disclosure to the outside.

Note that the moving picture data request device 20 transmits the required format of the moving picture together with the moving picture data transmission request to the moving picture data management device 30 in the second embodiment. In place of this process, however, the moving picture data management device 30 may previously retain the designation of the moving picture data format pursuant to the specifications of the moving picture data request device 20. For example, the moving picture data format and the resolution, the size, etc of the moving picture may be retained together with an address or identifying information of the moving picture data request device 20. Then, when receiving the moving picture data transmission request from the moving picture data request device 20, the moving picture data format may be converted based on the information for identifying the moving picture data request device 20 with reference to the designation of the moving picture data format.

Further, if the format used in the moving picture data request device 20 is predetermined, the data may be converted into the fixed format. This is, for instance, a case in which the moving picture data request device 20 is limited to the mobile phone having the given specifications.

### Modified Example

In the first embodiment discussed above, the openable data is extracted from the moving picture stored in the moving picture database 5 and transmitted in response to the transmission request sent from the moving picture data request device 20.

In this case, the transmission request may contain a user ID for identifying the user. Further, the user ID is assigned to each set of the moving picture data managed by the moving picture data management device 30. Then, if the user ID of the user who requests the moving picture data request device 20 for the moving picture is coincident with the user ID assigned to the moving picture data, the requested moving picture data including the closed range is transmitted to the user. Whereas if the user ID of the user who requests the moving picture data request device 20 for the moving picture is not coincident with the user ID assigned to the moving picture data, the data including only the open range but excluding the closed range may be extracted.

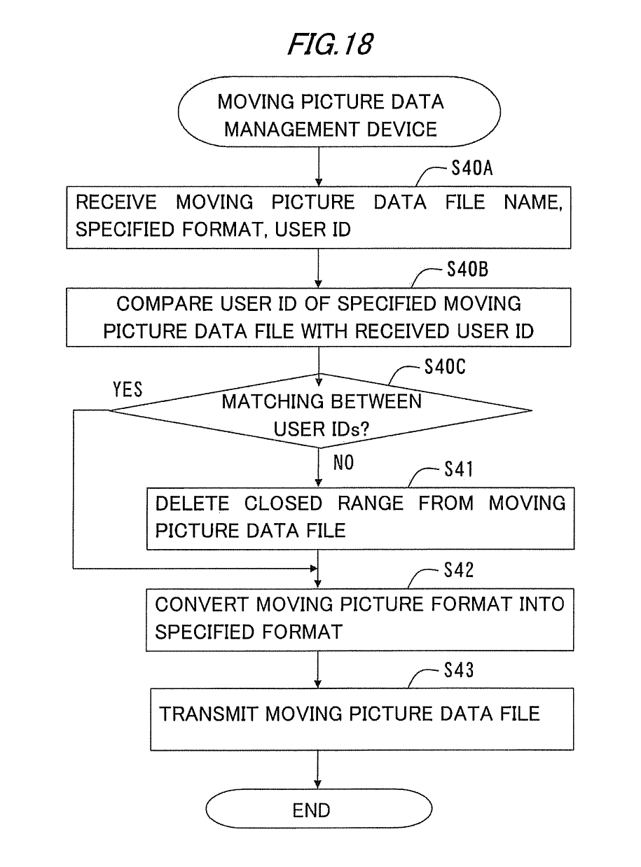

FIG. 18 illustrates an example of a process in which it is determined based on the user ID whether the closed range of the moving picture data is required to be deleted or not. In this process, the moving picture data management device 30 receives the moving picture data transmission request containing the designations of the moving picture data file name, the format and the user ID from the moving picture data request device 20 (S40A). The moving picture data management device 30 executing this process corresponds to a communication partner user information acquiring unit.

Then, the moving picture data management device 30 obtains the user ID of the moving picture data file with its transmission requested from the moving picture database 5. The moving picture data management device 30 executing this process corresponds to the communication partner user information acquiring unit. Then, the moving picture data management device 30 compares the user ID of the moving picture data file with its transmission requested with a receiving user ID (S40B). Subsequently, if these two user IDs are not coincident with each other (NO in S40C), the moving picture data management device 30 excludes the closed range from the moving picture data file (S41). While on the other hand, if these two user IDs are coincident with each other (YES in S40C), the moving picture data management device 30 advances the process to S42. The subsequent processes are the same as in the case of FIG. 17.

The processes described above enable the user to obtain the moving picture data including the closed range in the case of user's requesting, via the moving picture data request device 20, the moving picture data management device 30 for the moving picture data for the user himself or herself. On the other hand, if a person other than the user having the user ID retained in the moving picture data file makes the request for the moving picture data, the moving picture data file excluding the closed range is provided. Thus, the open range can be elaborately controlled corresponding to the user of the moving picture data request device 20.

### Third Embodiment

The second embodiment has exemplified the synchronizing process between the moving picture data request device 20 and the moving picture data management device 30. In the information processing system according to the second embodiment, the moving picture data management device 30 manages the moving picture database 5 and provides the moving picture data in response to the request of the moving picture data request device 20.

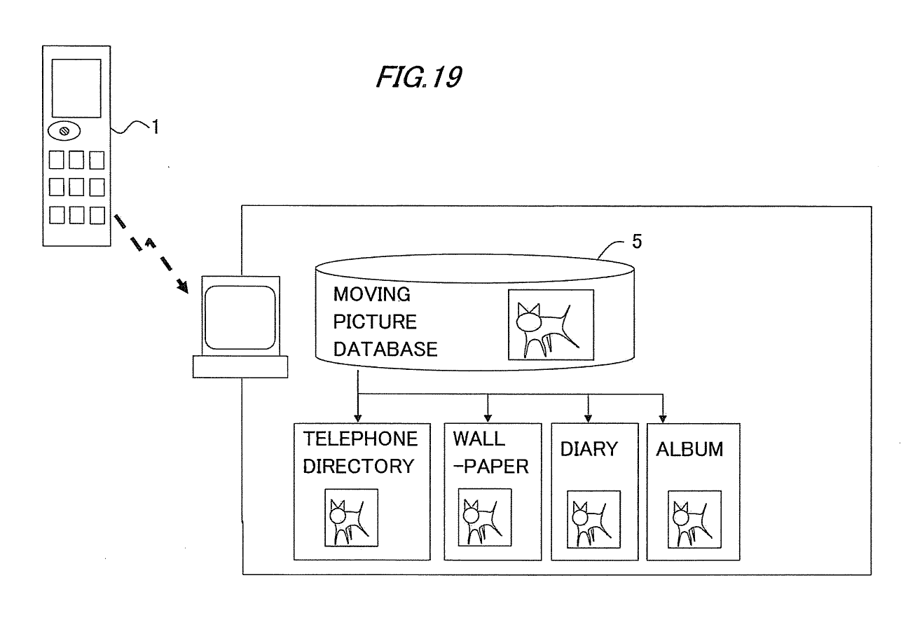

In place of such a configuration, the moving picture data request device 20 may be provided with the moving picture database 5. On the other hand, the device, which provides the data to the moving picture data request device 20, may be, e.g., the mobile phone etc incorporating the camera. FIG. 19 depicts this configuration.

In the configuration of FIG. 19, for example, the data of the moving picture captured by the mobile phone 1 is supplied to the moving picture data request device 20 and stored in the moving picture database of the moving picture data request device 20. At this time, the user may set the openable range or the closed range (see FIG. 15) through the key 4 of the mobile phone 1 or the input means of the moving picture data request device 20, and may store the set range in the moving picture database 5. The moving picture data request device 20 executing this process corresponds to a data range accepting unit.

The moving picture database management program 11 is executed on the moving picture data request device 20, and the moving picture data is supplied to the variety of applications. The processes of the moving picture database management program 11 and of the application program 12 in this case are the same as in the case of the first embodiment or the second embodiment.

<<Recording (Storage) Medium Readable by Computer>>

A program for making a computer, other machines, devices (which will hereinafter be referred to as the computer etc) actualize any one of the functions given above, can be recorded on a recording (storage) medium readable by the computer etc. Then, the computer etc is made to read and execute the program on this recording medium, whereby the function thereof can be provided.

Herein, the recording (storage) medium readable by the computer etc connotes a recording medium capable of storing information such as data and programs electrically, magnetically, optically, mechanically or by chemical action, which can be read from the computer etc. Among these recording mediums, for example, a flexible disc, a magneto-optic disc, a CD-ROM, a CD-R/W, a DVD, a DAT, an 8 mm tape, a memory card, etc are given as those demountable from the computer etc.

Further, a hard disk, a ROM (Read-Only Memory), etc are given as the recording (storage) mediums fixed within the computer etc.

The information device (the information processing system, the moving picture data request device or the moving picture data management device 30) stores the moving picture data in the way of being associated with the identifying information in the moving picture database. Further, the information device executes the plurality of applications. The information device accepts the read request for the moving picture data specified by the identifying information, reads the moving picture data specified by the read request from the database unit, and hands over the readout data to the requester application making the read request. Accordingly, the information device is capable of handing over, in a simple and systematic procedure, the specified moving picture data to the plurality of applications requiring the moving picture data.

According to the embodiment, in the information device accumulated with the moving pictures, the moving pictures can be provided to the plurality of applications, or the function of utilizing the moving pictures among the plurality of devices can be improved.

All example and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiment(s) of the present invention(s) has (have) been described in detail, it should be understood that the various changes, substitutions, and alterations could be made hereto without departing from the spirit and scope of the invention.

What is claimed is:

1. An information device comprising:
a database unit stored with moving picture data associated with identifying information for identifying the moving picture data;
an accepting unit to accept a read request for the moving picture data specified by the identifying information from any one of a plurality of applications which reproduce the moving picture data;
a data management unit to read the moving picture data specified by the read request from the database unit and handing over the moving picture data to the application making the read request; and
an execution unit to execute the plurality of applications which reproduce the moving picture data handed over from the data management unit;
wherein the information device further comprises a data range accepting unit to accept an input of allowable data range allowed to become a processing target by the application and
the database unit is stored with the input allowable data range together with the moving picture data.

2. An information device according to claim 1, wherein the moving picture data management unit includes an input unit to accept a moving picture data input request and to input the moving picture data in response to the moving picture data input request.

3. An information device according to claim 1, wherein the application executed by the execution unit includes at least two or more of a telephone directory management application, a wallpaper display application, a diary creation/display application and a moving picture album application.

4. An information device according to claim 1, further comprising:
a communication unit to communicate with another information device; and
a data format changing unit to change the data to be transmitted into a data format in which the data is displayed by the another information device,
wherein the data management unit accepts a transmission request of the moving picture data not existing in the another information device but stored in the database unit or the moving picture data stored in the database unit and having an update date/time later than the moving picture data existing in the another information device via the communication unit, and transmits the moving picture data with the transmission request accepted and with the data format changed to the another information device.

5. An information device according to claim 4, further comprising:
a communication partner user information acquiring unit to acquire information for specifying a communication partner user of the another information device; and
a self-user information acquiring unit to acquire information for identifying a user of the moving picture data stored in the database unit,
wherein the data management unit, if the communication partner user information is not matched with the user of the moving picture data, transmits the data in a way that limits the data to the allowable data range, and, whereas if the communication partner user information is matched with the user of the moving picture data, transmits the data without limiting the data to the allowable data range.

6. An information device according to claim 4, wherein the data management unit makes the request for transmitting the moving picture data not existing in the database unit but stored in the another information device or the moving picture data existing in the another information device having an update date/time later than the moving picture data stored in the database unit, receives the moving picture data transmitted in response to this request, and stores the received data in the database unit.

7. A computer readable medium storing executable instructions that, when executed by a computer, cause the computer to manage a database unit stored with moving picture data associated with identifying information for identifying the moving picture data, the executable instructions causing the computer to perform:
accepting a read request for the moving picture data specified by the identifying information from any one of a plurality of applications which reproduce the moving picture data; and
reading the moving picture data specified by the read request from the database unit and handing over the moving picture data to the application making the read request;
wherein the executable instructions further causes the computer to accept an input of the allowable data range allowed to become a processing target by the application; and
to store the input allowable data range together with the moving picture data.

8. The computer readable medium according to claim 7, further causing the computer to perform:
input accepting to accept a moving picture data input request together with the identifying information of the moving picture data; and
data inputting to input the moving picture data to the moving picture database in response to the moving picture data input request.

9. The computer readable medium according to claim 7, further causing the computer to perform:
communicating with another information device;
accepting a transmission request for transmitting the moving picture data not existing in the another information device but stored in the database unit or the moving picture data stored in the database unit having an update date/time later than the moving picture data existing in the another information device;
changing the moving picture data into a data format in which the data is displayed by the another information device; and
transmitting the moving picture data with the transmission request accepted and with the data format changed to the another information device.

10. The computer readable medium according to claim 9, further causing the computer to perform:
acquiring information for specifying a communication partner user of the another information device;
acquiring information for identifying a user of the moving picture data stored in the database unit; and
transmitting, if the communication partner user information is not matched with the user of the moving picture data, the data in a way that limits the data to the allowable data range, and transmitting, whereas if the communication partner user information is matched with the user of the moving picture data, the data without limiting the data to the allowable data range.

11. The computer readable medium according to claim 9, further causing the computer to perform:
making the request for transmitting the moving picture data not existing in the database unit but stored in the another information device or the moving picture data existing in the another information device having an update date/time later than the moving picture data stored in the database unit;
receiving the moving picture data transmitted in response to the request; and
storing the received moving picture data in the moving picture database unit.

12. A method by which a computer including a database unit stored with moving picture data associated with identifying information for identifying the moving picture data, the computer executing:
accepting a read request for the moving picture data specified by the identifying information from any one of a plurality of applications which reproduce the moving picture data; and
reading the moving picture data specified by the read request from the database unit and handing over the moving picture data to the application making a read request;
wherein the computer further accepts an input of the allowable data range allowed to become a processing target by the application; and
stores the input allowable data range together with the moving picture data.
